(19) United States
(12) Patent Application Publication
(10) Pub. No.: US 2006/0140108 A1
(43) Pub. Date: Jun. 29, 2006

(54) Double-sided, hybrid optical data carrier in disc format (sacd/dvd)

(76) Inventor: Stefan Schreiber, Kulmbach (DE)

Correspondence Address: SACCO & ASSOCIATES, PA, P.O. BOX 30999, PALM BEACH GARDENS, FL, 33420-0999, US

(21) Appl. No.: 10/534,400

(22) PCT Filed: Nov. 4, 2003
(86) PCT No.: PCT/EP03/12265

§ 371 Date: Jan. 23, 2006

(30) Foreign Application Priority Data
Nov. 11, 2002 (DE) 102 52 339.8

(51) Int. Cl. G11B 7/24

(52) U.S. Cl. 369/275.1

(57) ABSTRACT

The invention relates to a double-sided optical data carrier that contains, on the two sides, data in different logic and/or physical formats. One side conforms to the standard specification of a Super Audio CD (SACD), whereas the second side contains data in a format that differs therefrom and is preferably DVD-Video and/or DVD-Audio. The invention makes it possible for example for a hybrid SACD/DVD-Audio to be introduced, on which one side contains music for SACD players whereas the other side is compatible with DVD-Audio players. In addition, a hybrid SACD/DVD-Video can be produced that, on the SACD side, contains music in a high-resolution format, whereas the DVD-Video side mixes music and video, something which, to the inventor, seems essential for a broad spectrum of music (video clips for rock/pop, live video of jazz, music videos of operas, musicals and ballets, live recordings of concerts, etc.).

Now that the DVD, as a new video format, has begun its triumphal progress, which is comparable with the success of the compact disc as a data carrier for audio, efforts are currently being made to introduce formats for recording music to the very highest quality which are intended to surpass the CD as an established standard, and which are also intended to have new attributes which the CD does not provide (surround sound, music video, interactivity).

At the moment there are three formats that are contending with one another as potential successors to the CD:
1. DVD-Video as a music medium, which is based, like the CD standard, on LPCM (linear pulse code modulation) but with a sampling rate of up to 96 khz/24-bit in stereo and (compressed) surround sound formats.
2. DVD-Audio: LPCM sampling rates of up to 192 kHz/24-bit for stereo, 5.1 surround sound (maximum of 96 kHz/24-bit); lossless compression (MLP); there are a plurality of scanning rates available (44.1 kHz, 48 kHz, 88.2 kHz, 96 kHz, 176.4 kHz, 192 kHz), each of an accuracy of 16, 20 or 24 bits.
3. SACD: The format proposed by Philips/Sony, which is based on DSD (Direct Stream Digital). The latter is a bit-stream (1-bit sigma-delta modulation) with 64 times the CD sampling rate (2.8224 MHz).

Format 1 is occasionally referred to as “Digital Audio Disc” (DAD), and in German occasionally as “Musik-DVD”. The advantage of this format lies in the fact that it can be reproduced by any DVD-Video reproducing device. However, the specifications for DVD-Video state that audio signals with a sampling rate of 96 kHz may be converted to 48 kHz because many DVD players use digital-to-analog converters for 48 kHz.

Surround sound (also referred to as multi-channel sound) is defined in DVD-Video but only in a compressed form (Dolby Digital). The “Digital Theatre System” (DTS), which is certainly more suitable for music because it is less compressed, is only envisaged as an option and therefore often tends to be supported more by better/more expensive DVD reproducers. A special form of DTS is the relatively new DTS 96/24, which comprises LPCM channels with a sampling rate of 96 kHz. This system is backwardly compatible with the previous DTS system, that is to say that DTS reproducers see a DTS data stream (sampling rate 48 kHz) whereas the higher frequencies are situated in a DTS extension stream.

DVD-Audio was introduced as a format for high-resolution music and in this respect is superior to DVD-Video. Thanks to lossless compression (Meridian Lossless Packing/MLP), a recording in 5.1 surround sound can be accommodated on a DVD-5 without any compression-induced losses. A stereo version too of the same music can of course be made available on a DVD-Audio as a second audio stream. Unlike DVD-Video reproducers, a DVD-Audio reproducing device meets certain minimum requirements that have to be met if it is to reproduce music to a potentially higher standard than a CD player, e.g. it is mandatory for such reproducing devices to have digital-to-analog converters with sampling rates of at least 96 kHz.

DVD-Audio uses six different sampling rates each of a dynamic accuracy of 16, 20 or 24 bits. Stereo-channel recordings and surround sound versions on up to six channels can be made available in different variants. What is normally involved is the 5.1 process known from Dolby Digital which has a “low frequency effects” channel.

A more comprehensive description of the DVD-Audio format can be found in, for example, Jim Taylor: “DVD Demystified”, McGraw-Hill, 2nd ed. New York, 2001, Chap. 6, p. 250ff, ISBN 0-07-135026-8.

There was one DVD-Audio format that was provided for from the outset when the DVD standard was defined. The DVD file system includes a “Video title set” and an “Audio title set”. Even though the definition of the DVD-Audio standard was not completed until 2000, due to this piece of foresight it is relatively easy to produce a DVD that combines the above-mentioned formats nos. 1 and 2. This is occasionally referred to as DVD-AudioV or DVD-AV, or in other words is a DVD-Audio which can also be played on a DVD-Video reproducing device and can for example contain a stereo recording in 96 kHz/24-bit PCM and surround sound in the Dolby Digital format. In German usage, this format too is occasionally referred to as “Musik-DVD”.

Because formats 1 and 2 can thus be combined, it could be said that there are at the moment two formats for “high-resolution” digital music which are contending with one another: formats which are based on the DVD specifications, and the Super Audio CD from Sony and Philips.

Unlike DVD-Video or DVD-Audio, the SACD does not use pulse code modulation (PCM) but is based on a “bit-stream” process. The basic DSD (Direct Stream Digital) coding is a 1-bit sigma-delta modulation with a sampling rate of 2.8224 MHz (64 times the CD rate), combined with high-order noise shaping. This DSD format of Philips and Sony was developed more than 10 years ago for the archiving of analog master tapes. Because archiving in the CD format (44.1 kHz PCM) or on DAT (48 kHz, accuracy of up to 24 bits) was clearly not good enough to allow historic recordings to be archived digitally on analog tapes without any loss of quality, Sony and Philips looked for a format that had “more analog” characteristics than the conventional PCM modulation.

Bit-stream processes and sigma-delta modulation are of course older than the DSD process. For example, for the reproduction of CD's 1-bit converters were developed which are able to reproduce CD's by using 128 times or 256 times oversampling, it being known that the compact disc contains music in the PCM format (44.1 kHz/16 bits). In contrast to these bit-stream D/A converters, DSD is a proprietary format which will now be very briefly explained.

An analog recording—a digital recording too can of course be converted into DSD—is sampled at a frequency of 2.8224 MHz with an accuracy of only 1 bit. Expressed in very simplified terms, a “1” means a rise in the waveform and a “0” a fall. This explanation is, admittedly, slightly incorrect or over-simplifying but at the same time it gives a clear picture.

To achieve adequate dynamic characteristics, the quantizing noise is shifted to higher frequency ranges by 5th or 7th order noise shaping. According to Philips and Sony, the dynamic bandwidth which can be achieved is 120 dB in the audible frequency range, and in my opinion is around 115 dB or 19 bits. It is hardly possible to determine an exact value and the author would point out that even with the Super Audio compact disc it is still possible to hear signals which are below the quantization noise level (similarly to the LP, where sounds far below the analog noise level can still be heard).

One enormous advantage of sigma-delta analog-to-digital conversion is that no filters of any kind, such as anti-aliasing filters, need to be used at the recording end.

Later on, I shall be comparing the characteristics of DSD, PCM and analog recordings. Experience clearly shows that very good analog-to-digital converters can be designed which are based on ΣΔ modulation. However, in recording studios, as well as of 1-bit converters more and more use is being made nowadays of ΣΔ multibit converters, which are normally 5-bit or 8-bit converters. One reason for this is that multibit-coded music of this kind is considerably easier to process digitally than DSD. In the opinion of the inventor, nowadays 44.1 or 48 kHz PCM converters cannot be considered anything other than limited from the professional point of view.

As well as the basic DSD modulation, the SACD, like the DVD-Audio, also has a lossless method of compression for the bit-stream in question. This method is referred to as “Direct Stream Transfer”, or DST for short.

Now that an enormous amount of fuss has been made about Meridian Lossless Packing/MLP for DVD-Audio, which has a compression factor of approximately 1:2, there is one thing that should be made clear and that is that DST is more effective (average compression from 1:2.3 to 1:2.7).

The anticopying protection of the SACD has been carefully thought out and has a plurality of lines of defence against potential attackers. Amongst other things, a decoding key is modulated into a slightly varying bit width of the pits/lands on every SACD (PSP-PDM: pit signal processing/physical disc mark). What is more, an ordinary DVD drive for example cannot read the (encrypted) data on a SACD because even the lead-in is encrypted (SACD mark).

A very important characteristic of the SACD format is certainly the fact that a hybrid SACD/CD in which, as well as the high-resolution SACD layer, an SACD disc also has a CD layer below it, has been defined in the standard. The SACD layer is situated at a depth of approximately 0.6 mm and the CD layer at, for example, 1.2 mm, as envisaged in the CD standard. The SACD layer reflects red light (approx. 20% reflection) but is very transparent to infrared light, and a CD player therefore detects a CD having approx. 70% reflection.

The hybrid SACD/CD allows a catalogue of SACD's to be introduced which can be played not just by the present small minority of users of an SACD player.

However, the manufacture of a hybrid SACD/CD is somewhat more complicated and costly than that of for example a dual-layer DVD, but what is even more important is the fact that the production capacity that is available worldwide for SACD's is considerably smaller than it is for CD's and even for DVD's. If the widespread introduction of the hybrid SACD as a replacement for the CD were proposed, it would be thwarted at the present time by the lack of production capacity.

The SACD standard given in the “Scarlet Book” (Sony/Philips, 1999) also defines one-layer and dual-layer versions of the Super Audio CD which are implemented from the production point of view as a DVD-5 and a DVD-9 respectively. These formats are not of course backwardly compatible with the CD.

Because this obviously relates to the purpose of the proposed invention, the author of the present patent would now like to bring up the question of whether the tried and tested compact disc actually needs a replacement. The characteristics of PCM and DSD will be compared, for which purpose recourse will be had to experience in the field of recording technology.

In the opinion of the author, the reason for the triumphant world-wide progress of the compact disc was and is the fact that the CD was found to be more convenient, transportable and preservable and freer of noise than the long-playing record. A successful advertising campaign (“Perfect sound forever”) may likewise have played a major role, as also did the general trend towards digital during the eighties.

The CD succeeded even though many first-generation CD players, seen from the perspective of today, sound poor both objectively (by measurement) and subjectively. For example, many first-generation converters were only 14-bit converters. CD players often have what are called brickwall filters which, with a sampling rate of 44.1 kHz and the reproduction of a frequency range of 20 kHz (the sampling rate of 44.1 kHz reproduces, as is known, frequencies of up to 22.05 kHz), are unable to operate without artefacts because the filtering is steep. The fact that the standard of reproduction of the CD players was not very much optimised in the early days is proof that this format presented itself as “the” future format, that it was, precisely, more convenient than the vinyl disc and was therefore capable of proving to be a winner.

The conventional LP was still just as good as it ever was, but became more of a format for audiophiles, who looked upon the compact disc as a wrong road that had been taken.

CD players were improved in a number of successive phases and today can no longer be dismissed as “low-fi”. On the best of today's reproducing devices, CD reproduction is “good”, but in the opinion of many is not “very good” or excellent. By using improved methods of oversampling (“upsampling”, introduced by dCS and others with the help of improved signal processing), novel methods of interpolation and digital filters and by employing a new generation of D/A converters, the latest generation of CD players come close to the level of “authentic” PCM/96 kHz recordings. DSD however is regularly classed as rather better.

However, because of the high proportion of noise with DSD in the ultrafrequency range, particularly between 50 and 100 kHz, the reproduction of DSD may present problems with some amplifiers and loudspeakers. Amplifiers may even burn out (depending on their design) or be damaged, and forms of intermodulation may occur which degrade the quality of reproduction. If amplifiers and loudspeakers have been designed for these high-frequency components in the sound spectrum, such effects can however be largely minimised/ruled out. A basic problem of many of today's SACD players is that, because of problems with high-frequency components of the sound, an analog low-pass filter is used which, for reasons relating to the safety of the reproducing chain, comes into operation at a relatively low level (e.g. 40 kHz), although from experience low-pass filters might sound better from, for example, 80 kHz.

If, according to the classic theory of acoustics, one is only able to hear a frequency range of 20 kHz, why then is a sampling rate of 48 kHz not good enough for “perfect” recording of music? Apart from the fact that some few young listeners are able to hear up to at least 25 kHz and the dynamic bandwidth of the CD of, perhaps, 110 dB (with dither) is not sufficiently large for all requirements (in particular, the dynamic resolution of the compact disc becomes ineasingly inaccurate in soft passages, precisely where the accuracy ought, in fact, to increase), I am in fact aware of one study according to which the timbres of sounds and therefore probably also mono channels can be reproduced perfectly by 48 kHz/24-bit PCM sampling. However, it is the author's belief that a higher sampling rate is required for listening where there is a spread of sound, i.e. for stereo and surround sound. It is known that many listeners are able to distinguish differences in the transit time of an audio signal between the two ears of as little as three microseconds, which would correspond to a sampling rate of more than 300 kHz, regardless of whether it was in PCM or some other digital format. I am aware of the argument that in a CD recording the spatial resolution between the two channels can be made as high as desired by certain dither processes but I have serious doubts about this theory, both on acoustic grounds and on grounds drawn from information theory.

The author is himself a musician and has taken part in studio recordings using various recording formats. From my own experience, I am therefore of the opinion that recordings on analog tape or in high-resolution digital formats sound better and more convincing than recordings at 44.1 or 48 kHz. They sound more authentic, but above all more emotional, more moving and more “live”. Analog tape recordings have always had this characteristic but at times they have been replaced by inferior digital formats in the studio.

Comparisons between studio recordings from the same sources in the DSD and 96 kHz (DVD-Audio) formats have been made on a number of occasions. Both formats were felt to be very good, with the test subjects being found to have a clear preference for DSD.

According to the dCS company, this preference for DSD also exists in comparison with recordings in the 176 kHz/PCM format, with the actual ratio shown by the test subjects being 70:30. The dCS company produces, amongst other things, combined converters for PCM and DSD and would therefore appear to count as relatively impartial as far as having an interest in a particular format is concerned.

To be fair, it has to be said that the differences between PCM at 96 kHz and above and DSD were not felt to be great, but the recordings in question could be distinguished.

DSD is described as a format giving greater fidelity to detail and greater depth, very high resolution, and exact placing of instruments and as sounding “analog”, “open” and “natural”. PCM at 96 kHz and above is also described as “very good” with rather less depth, “dryer” medium and high frequencies, but better bass than DSD (the bass range with DSD is however also superior to PCM at 44.1 kHz under the CD standard). High-resolution PCM is almost never referred to as sounding “hard” or “glassy”, which would be a typical classification with (moderate?) CD reproduction.

In the report on a multi-format comparison which the author has available to him, the preference for DSD over 96 kHz PCM is described as “typically” 8:2, which is a good match with the above-mentioned study by dCS.

In the above tests, it was only the SACD and DVD-Audio formats which were compared. In the opinion of many experts, the best digital-to-analog converters are multi-bit sigma-delta modulators. Both analog tape, DSD and 96 kHz PCM recordings are considered to be not fully “transparent”, i.e. not indistinguishable from the analog material which is recorded. It is unknown to the author whether there are in fact any analog-to-digital converters which possess this ideal transparency. More acoustic research evidently needs to be done in this regard.

These comparisons of DSD and PCM in the studio are more meaningful that comparisons between SACD and DVD-Audio players in the audiophile press because it is only rarely that identical DVD-Audio and SACD recordings exist. This type of comparison is also of little interest when even the best commercial reproducers are only very rarely of studio quality even though their prices may occasionally be higher. For a comparison of quality, it would seem that only a test under optimum conditions would be of any interest. Generally, the SACD meets with positive acceptance from people who prefer the sound of the LP to that of the CD. It is judged by this group to be relatively “analog” sounding. It is possible that good DSD converters can be produced more easily than PCM D/A converters but certainly converting both formats well is far from straightforward. If that really is the case, then SACD might be considered the more convenient format than DVD-Audio, because good reproducing equipment could be produced more easily.

It is no great secret that the music industry would like to get away from the CD, in that it is not a copy-protected format, which results in there being an interest in principle in the introduction of DVD-Audio and SACD. The anticopying protection methods for SACD have already been mentioned but DVD-Audio too has effective anticopying protection (CPPM=content protection for pre-recorded media). Provision is also made in the standard for a method that inserts watermarks in the music recording, but it possibly degrades the quality of the audio. It is not however obligatory for Verance watermarks to be used.

The fact that two formats are contending with one another as successors to the CD makes their introduction uncommonly difficult. The competition between potential successors to the CD seems to me to be even more detrimental than the conflict between writable DVD formats, because a DVD-RW or DVD+RW can potentially be understood by any DVD-ROM reader if the latter is able to deal with its lower reflectance and the minimal differences in the lead-in.

DVD-Audio and SACD are two genuinely different formats which have not so far been able to be combined on the same medium. It is obvious that at the moment many potential buyers are adopting something of a wait-and-see attitude until one format comes out on top. Because there is justification for both formats (DVD-Audio is the legitimate expansion of the DVD-Video standard, while the Super Audio CD can in fact be considered an improved CD), it does not at the moment look as if either format will come out on top as a clear winner in the foreseeable future.

It is known that, in the course of the development of the DVD-Audio format, discussions were underway between the DVD-Forum and Philips/Sony regarding the incorporation of DSD modulation in the DVD-Audio standard. Because this would probably only have been accepted in the form of a possible option (and hence seldom applied, see DTS), Sony and Philips broke off these negotiations and in 1999 put the SACD on the market, initially as a stereo format. The DVD-Audio followed a year later, while the first surround sound recordings for the Super Audio CD were introduced somewhat later still. If an SACD contains a surround sound version of a recording, it must always contain a stereo version of this music as well, unlike the DVD-Audio which is permitted to convert a recording in surround sound technology to stereo. However, this form of “stereo” is not identical with a recording that was stereo at the time of recording, precisely because the latter would not normally have been recorded in the same way as a surround sound production.

The hybrid SACD is compatible with almost all CD players but not with all DVD-Video reproducers, some of which would attempt to reproduce a DVD layer which, as they saw it, was damaged.

A hybrid DVD-Audio with a CD layer was officially permitted by the DVD Forum in October 2002 but is faced with one serious problem. Many, if not the majority, of conventional DVD players (for video) first try to reproduce a CD layer, i.e. they would not play the DVD layer that was relevant to them even if the DVD-Audio contained a DVD-Video-compatible section. This of course is not what is intended to happen with a hybrid DVD/CD. The success of a hybrid DVD-Audio/CD is therefore more than questionable due to the absence of backward compatibility with DVD-Video, and this hybrid variant ought probably to have been defined back when DVD-Audio was introduced, which did not happen.

To alleviate the problem of two incompatible high-resolution audio formats, the introduction of hybrid SACD/CD players which are able to reproduce both formats has been suggested.

In the opinion of the inventor, this strategy for bringing to an end the competition mentioned between two similar formats will not work. A hybrid DVD-Audio/SACD player would always be considerably dearer than a solution for only one format.

Even if chips which incorporate the different anticopying mechanisms for DVD-Audio and SACD are developed, and so too are digital-to-analog converters which convert both PCM and DSD too to a high standard (which are still very dear at the moment), the analog section downstream of the D/A converters is differently constructed for DVD-Audio players and SACD players. The filters are different (only one low-pass filter for SACD), as also are the jitter monitoring and even the pre-amplification of the signals. Even though DSD is easy to convert in theory, what is required in practice is an analog path of high quality which is, precisely, not identical with the analogue path for a PCM conversion.

In practice, a hybrid DVD-Audio/SACD player will therefore turn out to be more expensive both in respect of its digital section and (and probably above all) in respect of its analogue section than a dedicated player for either one of these two formats.

The rather poor reproduction of CD's found with DVD/SACD players proves that multi-function devices are not able to meet all the requirements equally well even though this ought to be possible in theory. However, in CD reproduction, the format used (44.1 kHz/16-bit) could be converted digitally into whatever was the initial format in the given case: 96 kHz/192 kHz/DSD (by upsampling), as a result of which only one analogue path would be needed for the reproduction of CD's and of a better format. (This would not entail any sacrifice of quality because the very thing that many of the best CD players do is to use a form of upsampling to 96, 176 or 192 kHz in order to reproduce CD's. It would take up too much space to give details here but methods have been found of radically reducing the artefacts from digital filtering. The high quality of reproduction given by state of the art processes used by dCS and others is based on a more advanced understanding of the theoretical principles of analogue/digital filters and interpolation processes.) However, high-sampling-rate DSD and PCM cannot be converted into one another satisfactorily because in both cases doing so would entail a reduction in quality. DSD has a higher temporal resolution/pulse reproduction/better spread of sound, while 24-bit PCM is perfect as far as dynamics are concerned. What this means is that a hybrid SACD/DVD-Audio player should reproduce both DSD and LPCM on separate paths and not simply convert them into one another. Even though hybrid players exist that do that very thing, they are of course better for the process that is supported by their D/A converter and analogue path.

Because their price would be higher than that of a unit based on a single format, hybrid SACD/DVD-Audio reproducers would not find things easy for them on the market, especially as the SACD and DVD-Audio formats are increasingly being incorporated in DVD-Video players as additional formats. A player which reproduces DVD-Video's/CD's/SACD's and DVD-Audio's each to a high standard of quality is not of course very cheap, regardless of the fact that it would of course be possible to produce reproducers having one or a small number of chips that “understood” these formats. Because of the analogue components that are needed for different audio formats, the price will always be higher than that of dedicated reproducers.

The hybrid SACD/DVD-Audio reproducers that have appeared to date only corroborate these theoretical considerations. Without wishing to name any companies, these have so far been either low-cost units which are not hi-fi reproducers in the true sense, or have been players which are clearly better at reproducing one of the two high-resolution formats. None of these units can be considered a reference CD player.

Many companies obviously have no interest in producing hybrid players. For example, many SACD players made by Sony and Philips are also DVD reproducers and are very well equipped for reproducing music-DVD's (“DAD's”). Some of these players contain DSD and PCM converters for 192 kHz but, despite the potential which exists and the ability they already have to reproduce surround sound, evidently do not play DVD-Audio's. The explanation for this lack of hybrid capabilities on the part of the reproducers may be considerations of price and/or company policy.

To get round the desperate situation of having two incompatible formats in a market which is (at least initially) limited, I propose a new form of double-sided hybrid disc which has data in the SACD format and the DVD format on respective ones of the opposing sides. Recordings/data in the SACD format can therefore be combined on the same medium with the same pieces of music in the DVD-Video and/or DVD-Audio format. In technical terms, it is easily possible for such media to be produced because one SACD layer is known to be produced on one DVD half-side, i.e. two DVD half-sides are combined with one another, which is a normal DVD production process. In this way, not only can different formats for the reproduction of music be combined but a defect which the SACD format has in principle is also remedied, namely the lack of ability to show video and specifically of compatibility with the DVD-Video format. “Compatibility with DVD-Video format wherever possible” was incidentally a demand made by the ISC (International Steering Committee, of the music industry) for a successor to the compact disc. In fact, what the ordinary public expect (rightly) from a successor to the CD is not only higher quality but also entirely new attributes, such as music videos and multi-media facilities.

So, an obvious solution to this problem is for pieces of music for which this is desired to be stored in the DVD-Video format as music video on the DVD side of the proposed hybrid SACD/DVD. The fact that the quality of sound is not quite as good as with the SACD would appear not to be of any great significance when one is sitting in front of the television and the very thing one wishes to do is to watch a music video. With television in its present form (even DVB), the musical quality is rather lower than with DVD-Video. It may also simply be pointed out that surround sound with DSD cannot be incorporated in DVD-Video because no satisfactory methods are (at present) known for the (lossy) compression of DSD. The data rate of DST-compressed DSD with MPEG-2-compressed video is clearly too high for (potential) use in the DVD standard, for which reason PCM-based methods (such as Dolby Digital, MPEG-2 surround sound and DTS) are to be preferred for video with surround sound, or in other words have absolutely no competition at the moment.

A video giving information on a piece of music or a composer, a recording, interpreters, etc., including for example with audio examples, can of course be stored as well on the DVD side.

Additional information on a hybrid SACD according to the present invention can also be accommodated on the DVD side in a dedicated (DVD-ROM) section which can be read and reproduced by a computer. In the case of the compact disc, this corresponds to the “CD-Enhanced” format, except that with the DVD there is a disparately greater amount of space available for music and multi-media data. This would be a sort of multi-media SACD, which could be interactive.

If an identical recording in different formats is stored on the double-sided hybrid SACD of the present invention, what I recommend for the recording technique is not for a DSD recording to be converted to PCM 96/24 and vice versa. The disadvantages of the two formats would be combined in each case, which does not appear to be very acceptable. DSD is “more natural”, is a filterless analogue/digital conversion which works excellently, and has very high temporal resolution but not 24-bit dynamic resolution. The quantization noise in the ultrafrequency range would have to be filtered in the conversion to PCM because, unlike components certified for SACD, amplifiers and loudspeakers in the reproducing chain for DVD-Audio will not necessarily be designed for severe high-frequency constituents of the sound. However, if these constituents are suppressed in the required way, certain items of real information (e.g. pulses) are lost. I recommend either that recording be carried out “authentically” in the two formats in parallel or that it be carried out in a third, neutral format (which is still analogue or in a very high-resolution PCM format or with more recent multibit sigma-delta converters). Possibilities other than those proposed will be clear to the person skilled in the art (e.g. higher frequency DSD). DSD as a recording format has the disadvantage of allowing itself to be processed digitally only with great difficulty, which is another point in favour of the above strategy. For distribution on the other hand, DSD/SACD is a very suitable format.

It is obvious that “perfect” audio formats which can be converted digitally into existing media without any trouble should be developed for studio use. Even for processing signals, studio formats require wider tolerances and higher resolutions and bit-depths than was originally expected.

In what follows, various implementations and applications of the invention will be discussed. The said invention will however be defined simply by the claims relating to it, which are formulated in more general terms than the embodiments discussed. The examples given relate to embodiments which are of significance at the moment and to certain embodiments which will potentially be of significance in the fairly near future.

### PROPOSED EMBODIMENTS

1. A double-sided SACD, with the second side conforming to the standard DVD format. A hybrid SACD/DVD-Audio can be produced in this way, in which a piece/track/recording is produced in both formats and combined on the same sound-carrying medium. It is of course possible for a pack containing an SACD and an “identical” DVD-Audio to be offered for sale, but it is not of course in the interests of the record companies to sell two copies of a recording for what is substantially the same price. These SACD and DVD-Audio constituents should therefore be combined on the same data carrier, which is the case with the proposed hybrid solution. There is therefore no need for a purchaser of a recording in this combined format to wrack his brains over whether an SACD or a DVD-Audio has a more assured future because the recording is, logically, compatible with SACD and DVD reproducers. An SACD can also be combined with a DVD-Video, a DVD-AudioV and with computer programs and data which are intended for display on a multi-media PC (“enhanced SACD”, SACD/DVD-ROM).

The production of such a medium is quite simple. A hybrid data carrier of this kind will normally be produced by the DVD-10 process, i.e. by means of two DVD half-sides which are bonded together. The inventor would point out that an SACD layer of this kind is produced by a conventional DVD injection-moulding process in which a normal DVD half is produced, because an SACD substrate (approx. 0.6 mm) has, in physical terms, specifications which are the same as those of a DVD substrate and can be produced on any DVD line. It is merely the master (or “son”, meaning in general terms the matrix used) that requires, for production, an LBR (laser beam recorder) matched to the SACD process which is able to expose both the logic format used and also the physical anticopying protection (PSP-PDM).

If an SACD is combined with a DVD-Audio giving surround sound and DVD-Video on the B side, then for reasons of the space required this hybrid data carrier will probably have to be produced as a DVD-14.

The process that is being used at the moment for producing two-layer DVD halves on standard production lines is described in U.S. Pat. No. 6,117,284. It is the so-called “Surface Transfer” process owned by Time Warner, which has now been licensed by other firms. Other production processes have already been developed such for example as 3M's “2P process”/photopolymer process or the “printing” of DVD layers on thin polymer sheets or films. These processes are similar to known processes from offset printing, but with substantially higher resolution for the “printing” process in question.

The AIX company has produced a series of DVD-Audios in DVD-14 form.

If an SACD is to have a playing time of, for example, more than 80 minutes, or if there is additional material on the SACD side, a DVD-18 could also be produced, likewise by the Surface Transfer process under U.S. Pat. No. 6,117,284 for example. There would be two SACD layers on one side, and two further layers in a different format on the opposite side, i.e. a DVD-AudioV for example, possibly with a DVD-ROM area.

The double-sided optical disc of the present invention appears to the inventor to be one of the first really useful applications of three and four-layer DVD's (DVD-14 and DVD-18 respectively).
2. A hybrid SACD/CD having a CD layer at a depth of for example 1.1 mm, comprising a 0.6 mm SACD substrate and a 0.5 mm CD substrate, could be combined with a DVD layer bonded onto the second side.

The data carrier obtained could be produced on production lines for the hybrid SACD and would potentially be compatible with any of the current digital data formats for music, and therefore would in fact be “universal”. A data carrier can be produced which contains a recording in the CD, SACD, DVD-Video and DVD-Audio formats. However, like the known DVDPlus, this data carrier would be rather too thick (1.7 mm), given that the CD and DVD specifications allow data carriers of a thickness of up to 1.5 mm. CD players particularly therefore occasionally have problems with such media. The CD layer could possibly be produced on a 0.3 mm thick substrate. The CD layer would then be situated at a depth outside the CD-audio specification (0.9 mm rather than 1.2 mm or the bottom tolerance of 1.1 mm defined in the CD standard), but the resulting double-sided disc would accordingly be approximately 1.5 mm thick, a value which would be permissible. A CD player however expects a CD layer at a depth of between 1.1 and 1.3 mm and, because the lens would not be adjusted to this thickness, a layer at a depth of 0.9 mm would lead to a spherical aberration in reproduction, even with correct focussing.
3. Also conforming to the invention is a medium in which an SACD half-side is combined with a CD layer on the second side. This embodiment corresponds to a DVDPlus but there is no point to it because it is less compatible with CD players than a conventional “hybrid SACD” with a CD layer. This combination could, however, be produced on any DVD/CD line and not just on the few lines that there are at the moment for the hybrid SACD. The inventor mentions this possibility for the sake of completeness but does not have any belief in its usefulness. A variant of this embodiment would be the combination of an SACD half-disc with a hybrid DVD/CD on the opposite side. This likewise appears to be pointless because this disc would once again be about 1.7 mm thick and a hybrid DVD is only defined for DVD-Audio, which has been the case only since October 2002. These embodiments would be an additional invention to the basic patent, EP 745985, of JVC.
4. It is conceivable for an SACD half-disc to be combined with a future HD-DVD on the second side. The HD-DVD could contain video in the HDTV format and/or audio data in a hypothetical “perfect”, fully transparent sound format, should we ever see any such thing. Until then, thought should certainly be given to how surround sound is going to be played in a genuinely realistic way, because what is so far definitely lacking for this is at least one vertical channel. For this requirement, it is immaterial whether the future HD-DVD contains data at a layer depth of 0.6 mm (DVD half-disc) or 0.1 mm (“DVR-Blue” or “Bluray Disc”), because both formats are double-sided or can be implemented in double-sided form in an optical disc which is (normally) 1.2 mm thick. Special formats of an “HD-DVD” can also be produced on the second side, if for example special or competitive formats should be introduced.
5. The proposed invention is always a double-sided format and therefore potentially more prone to scratching than a single-sided DVD-5 or DVD-9. Although I have never heard of any complaints of this kind about double-sided DVD's for videos, I do consider this a potential problem. Substrate materials have now been developed (particularly for DVD-R/DVD-RW) which, according to company statements (e.g. by TDK), are up to 100 time more resistant to scratches than normal polycarbonate substrates such as are used for CD's and DVD's. Highly resistant materials for substrates are also under development for the next generation of DVD's. Under many proposals for the next generation of DVD's, the data-carrying layer will be situated at a depth of only 0.1 mm, which means that, should this data carrier be used without a cover or cartridge, even slight damage to the surface might interfere with reproduction. In the case of the proposed hybrid SACD/DVD, a protective film could of course be applied, even manually, to a little used or unused side of a hybrid disc according to the present invention, which film would naturally have to be capable of being removed again easily.
6. The inventor considers the small amount of space that is available for a label with any double-sided disc format to be a problem which can be ignored if there is a real additional benefit present. Externals are less significant than applications. There are many methods of identifying the two sides of a double-sided optical disc and there is no need for these to be mentioned here.
7. The size of a hybrid SACD according to the invention may be different from the standard size (diameter of 12 cm) and in particular smaller sizes (e.g. 8 cm) can be played on any player because in this case the file system of a DVD or SACD does not point to data in the outer region (of which there is not one) of the data carrier: a reproducer therefore does not even notice this difference in diameter. There also exist compact discs of other than the standard diameter (8 cm size, “shaped” CD's, even “cards” with a CD centre-hole).

Even now, any DVD replicator who pays the appropriate licence fees (under DVD and SACD patents for media and the present invention) is capable of producing a hybrid SACD/DVD according to the present invention without any problems, at least in the DVD-10 version, on virtually any present-day DVD production line. The immediate availability of the proposed hybrid solution is an invaluable advantage for its introduction. The patent fees for DVD and SACD data carriers are a few cents each. Certainly these double licence fees do have an impact measured against the production cost of a DVD of, at the moment, slightly below $/Euro 1, but have hardly any impact when compared with the price of high-quality music recordings, which are about $/Euro 20 or more for SACD and DVD-Audio.

It is the inventor's belief that, as a trend, it might be possible to ask a higher price for a hybrid SACD/DVD-Audio, which may even include video, because, due to its dual compatibility with SACD and DVD, this format has a more assured future and cannot become obsolete in the foreseeable future. One possibility is that SACD and DVD-Audio will continue to exist in parallel, and if this is the case then the hybrid solution opts for neither standard and will always be able to be played on future reproducers for both formats.

If one format should go under in the competitive struggle which can be foreseen, the hybrid format will still be compatible with the one that comes out on top and, what is more, will be an emergency solution for record labels and companies that wish to continue to support the format that becomes less important in future. I personally do not think that either of the formats will supersede the other in the foreseeable future. It is obviously a problem that three competing formats are taking the field against one very established format like the compact disc. The invention discussed enables a data carrier to be produced which combines these three(!) high-resolution formats as SACD/DVD-AudioV.

Higher costs for authoring hybrid formats would not appear to be a major consideration if software is developed which largely automates this process. SACD and DVD-Audio are almost pure audio formats, which means that an authoring program would be able to edit changes in the two formats largely in parallel.

Earlier on, the inventor was convinced by the hybrid SACD but is now no longer so and considers this to be an undoubted transitional solution. In my view, the music industry should strive to make a clear division between CD and high-resolution formats. CD's should be offered at appreciably cheaper prices than DVD-Audio's and SACD's, which will amount to a drop in the price of this format. This would undoubtedly be a sensible step to take against illegal copies of CD recordings. Generally speaking, the hybrid SACD/CD does not permit markedly low prices.

Also, because of its unprotected Red Book layer, the hybrid SACD is clearly a copyable format, which directly calls into question the excellent (digital) anticopying protection of the SACD. The average pirate copier who puts or copies MP3 files onto the net certainly does not need a high-resolution format to produce these files. SACD and DVD-Audio should be clearly positioned as higher-grade media offering surround sound, possibly expanded with video and interactive components. In the first place a higher price can be asked for this and in the second these formats are protected against copying, which really ought to go without saying for a new digital format. With music, anticopying protection does not in any way prevent (fair, private) copying, a point I shall be coming back to shortly.

The hybrid SACD/CD always has the fundamental defect of a lack of video characteristics. Even if video facilities are incorporated in the SACD standard in a more satisfactory form than they have been to date, there is quite simply no room on a hybrid SACD/CD, unless surround sound is abandoned, which would rather call into question the purpose of the SACD as a format for surround sound. It could therefore be said that the SACD is simply not designed for music videos, which clearly illustrates the significance of a hybrid disc for SACD/DVD-Video.

The hybrid SACD/DVD (Audio and/or Video) proposed by the author is cheaper to produce, at least in DVD-10 form, than a hybrid SACD with a CD layer, because the coating of a semi-transparent SACD layer is composed of a silicone compound (according to documentation from Philips), which cannot be produced by a conventional metal vapour deposition process for producing a layer of aluminium, silver or gold.

I am not aware of any prices for the production of DVD-14, but believe that what will probably be a higher price than a DVD-10 can easily be passed on to the end customer by virtue of the relevant added value in the form of corresponding audio/video and possibly multi-media productions. Such productions, which are (also and precisely) expensive in terms of authoring, are the very ones which ought to create some interest, particularly if they are well made.

The experience that I, as a musician, have myself had with the new high-resolution formats has been very satisfactory. The listening possible with them is easier and less effort, but for that very reason is also closer and more directed to the music. I in fact believe that the occasional lack of “musical” attributes shown by compact disc recordings have led to listening becoming more superficial.

Improved data carriers for digital music therefore appear to be urgently desirable.

A few thoughts about anticopying protection for audio data carriers also appear to be relevant. It can be assumed that copy-protected audio formats, including a hybrid SACD/DVD-Audio according to the present invention, could be criticised because of this attribute. All that can be done is to stress that no-one is prevented from recording a CD-R from this data carrier, or similarly producing a cassette, minidisk or an MP3 file, via an analogue input in each case of course. Whether SACD or DVD-Audio recordings should be output at lower resolution (44.1 kHz or 48 kHz) via interfaces such as S/PDIF can be left to the manufacturers of equipment. In the case of audio, the fair use principle will hardly be called into question by the anticopying protection because the recording of music on recording media which already exist is fairly straightforward. If the music publisher wished to permit a perfect digital copy on CD, he could do this under the invention presented by storing a file in 44.1 kHz/16 bit PCM in the DVD-Audio or DVD-ROM area (unnecessary, but possible in theory). Anticopying protection for new audio formats is a legitimate right of the music industry and in the case of DVD-Video (CSS) is no reason for putting obstacles in the way of the success of this format. There is certainly no right to a perfect 1:1 digital copy of high-resolution music. Purchasers of such recordings are in no way prevented from making an (analogue) copy on other media, including for example CD-R's or MP3 files. Hence, digital anticopying protection does not conflict with the fact that copies for private use are of course still possible.

The considerations which have been discussed unfortunately illustrate the problems there are with any anticopying protection for music. The best anticopying protection would undoubtedly be low prices for future CD's and dearer, but very high-quality, high resolution formats having additional facilities such as video, surround sound, multi-media, etc. It should be made clear to users that copying music is the same as copying books or software for example; in other words it is “pirate” copying particularly when copies of this kind are placed on the Internet.

Like the software industry, the music industry too will gradually come to terms with the new facts of life and, with a bit of creativity, will of course also be able to continue operating in such a way as to make a profit.

I personally consider the introduction of high-quality formats for music such as DVD-Audio and SACD to be extremely promising and think that it might make a crucial contribution to a renaissance of listening habits and a more profound engagement with music.

To sum up, the present invention presents hybrid data carriers which expand the present SACD standard. SACD recordings can be combined with videos on the DVD side, i.e. music videos which can be shown by normal DVD-Video reproducers can be incorporated in the SACD standard. Video attributes are only defined in a rudimentary form in the existing SACD standard. Conversely, it could be said that music videos under the DVD-Video standard are supplemented with an audio version of very high quality which, where possible, also includes surround sound without any compression artefacts.

Secondly, it is possible to produce hybrid media which contain data for SACD and DVD-Audio players. These media have an assured future and the issuer does not have to make a decision in favour of either the SACD or the DVD format (one side may of course exist in the DVD-AudioV format). As well as the obviously larger market it will have, this hybrid format also makes it easier for the consumer to decide to buy because he does not have to ask himself which format is “better” or is going to win the war of the formats that has been mentioned.

In fact, in the inventor's opinion both formats have pros and cons and of course, with the reproduction of music, the quality obtained depends not only on the format used for the sound but also on the design of the reproducer, which may be good or not so good. One can simply point out how much CD players have been improved over the years and how great the differences between models can turn out to be.

Generally speaking, the reproduction of SACD's and DVD-Audio's has not yet been optimised. I would mention the fact that even the recording technology for DSD is still being further improved at the moment (see papers given at the 112th AES Conference: Trellis process for noise-shaping for DSD; Pre-distortion correction for DSD; Methods for the digital processing of DSD).

It can be assumed that at the moment the vast majority of DVD players do not use very good D/A converters for 96/192 kHz, or do not meet the rigorous requirements for low jitter which conversion of 96 kHz into 20 or 24 bits now imposes. DSD is (probably) more tolerant of jitter.

The proposed hybrid SACD/DVD format appears to the inventor to make more sense than the hybrid SACD/CD because it makes a clear division between the market for CD (which in future will be the cheaper format) and that for high-resolution formats (combined), which may possibly be a very sensible thing to do. The hybrid SACD (like a hybrid DVD-Audio/CD) has the disadvantage of always comprising only one high-resolution layer and of therefore being suitable neither for video reproduction nor for recordings of some length.

The proposed invention can be implemented in the form of a DVD-18 with up to four layers. As can be seen from the claims, future formats (HD-DVD) or substrates having more than two data layers (e.g. FMD) can be incorporated on the side which does not include the SACD layer.

The description is based on readable media but under the present claims it is also possible for writable layers (or parts of layers) to be incorporated (on both sides).

The demand for surround sound would seem to be increasing due to the increasing widespread use of home cinemas. However, there is possibly also a great future for surround sound in a place where, on the face of it, this would not be expected, namely in the car. In the car, stereo reproduction is not in fact very convincing because of the unfavourable position in which the driver is seated relative to the loudspeakers and the excessively large angle of the loudspeaker/listener triangle. Surround sound therefore sounds far more realistic in a car than stereo.

The demand for media for music videos can be considered as a given when the success of music broadcasters such as MTV etc. is considered. The compact disc does not offer any video facilities, or does so only in the form of the video CD, which is not satisfactory for music reproduction of high quality. The demand for an optical disc for music videos is therefore perfectly understandable and the existing SACD standard is not a standard for music videos. The present invention expands the SACD standard in the appropriate way by incorporating a DVD-Video layer on a Super Audio CD.

1. Double-sided optical data carrier in disc format having at least two data layers, which contains at least one high-density data layer according to the Super Audio CD format on one side and at least one layer in a data format which differs therefrom physically and/or in respect of logic on the opposite side.

2. Data carrier according to claim 1, which has at least one data layer in the SACD format on one side and at least one data layer in the DVD-Video and/or DVD-Audio format on the opposite side.

3. Data carrier according to claim 1 wherein the SACD layer is situated at a depth of approximately 0.6 mm and the total thickness of the data carrier is between 1.1 mm and 1.5 mm.

4. Data carrier according to claim 1 wherein identical music or identical musical excerpts is/are stored on the two sides of the data carrier in different formats.

5. Data carrier according to claim 1 which contains at least one CD layer.

6. Data carrier according to claim 5, wherein the CD layer, seen from the read surface, is situated at a depth of less than 1.2 mm and preferably a depth of less than 1.1 mm.

7. Data carrier according to claim 1 wherein at least one layer is at least partly writable and/or rewritable.

8. Data carrier according to claim 1 which has a diameter of less than 12 cm and preferably a diameter of approximately 8 cm.

9. Data carrier according to claim 1, which contains at least one layer which is readable and/or writable and/or rewritable by a blue laser.

10. Data carrier according to claim 9, wherein the layer which is readable and/or writable and/or rewritable by the blue laser is situated on the same side as the SACD layer, below this latter layer, or on the opposite side of the data carrier from the SACD layer.

11. Data carrier according to claim 1 wherein the data carrier has at least two optical substrate discs, of which at least one is composed of a more scratch-resistant material than polycarbonate or of polycarbonate plus additives which harden the surface against scratching.

12. Data carrier according to claim 1 wherein the high-density data layer is intended for scanning by a red laser.

13. Data carrier according to claim 12, wherein the red laser has a wavelength of between 600 nm and 700 nm, and preferably one of 650 nm.

14. Data carrier according to claim 1 wherein the high-density data layer contains audio data in a 1-bit sigma-delta modulated audio format.

15. Method of recording audio data for producing a data carrier according to claim 1 wherein the audio data is recorded in a format which permits lossless or almost lossless conversion both into 1-bit sigma-delta encoding using a sampling rate of up to 2.8224 MHz and into pulse code modulation using a sampling rate of up to 192 kHz, and in that the audio data recorded is converted on the one hand into a format using 1-bit sigma-delta encoding at a sampling rate of up to 2.8224 MHz and on the other hand into a pulse code modulated format using a sampling rate of up to 192 kHz, the one format being intended for storage on one side of the data carrier and the other format being intended for storage on the other side of the data carrier.

16. Method according to claim 15, wherein the recording format is selected in such a way that an audible preference is given in the conversion neither to the 1-bit sigma-delta encoding using a sampling rate of up to 2.8224 MHz nor to the pulse code modulation using a sampling rate of up to 192 kHz.

17. Method according to claim 15 wherein the audio data is recorded neither by 1-bit sigma-delta encoding using a sampling rate of up to 2.8224 MHz nor by pulse code modulation using a sampling rate of up to 192 kHz.
